(19) United States
(12) Patent Application Publication
(10) Pub. No.: US 2007/0068359 A1
(43) Pub. Date: Mar. 29, 2007

(54) Friction in a grand piano completely eliminated by a third lever

(76) Inventor: Richard Wroblewski, Trumbull, CT (US)

Correspondence Address: Richard Wroblewski, 701 Silver Lane, Trumbull, CT, 06611, US

(21) Appl. No.: 11/237,702

(22) Filed: Sep. 29, 2005

(51) Int. Cl. G10C 3/18

(52) U.S. Cl. 84/236

(57) ABSTRACT

In a grand piano action friction between the jack and the knuckle completely eliminated by a third lever.

This relates to my patent application Ser. No. 10/878,002

### FIELD OF THE INVENTION

The present invention relates to grand pianos affected by the traditional friction at the jack and knuckle interface.

### BACKGROUND OF THE INVENTION

Conventional grand pianos are plagued by excessive friction at the jack and knuckle interface causing noise, wear and tear requiring frequent regulation and lubricant applied to reduce the friction. This friction is caused by gravity of the hammer assembly in combination with the jack spring, and by the wippen lever not working with the principle of Archimedes. The capstan screw on the piano key is too far from the distal end of the wippen lever.

### SUMMARY

In the present invention the wippen lever is lifted by the distal end of the wippen lever by the distal end of a third lever supported by the capstan screw on the piano key. This revolutionized grand piano action having the same characteristics as the original design i.e., the hammers being in the same position with respect to the tensioned strings, and maintaining the same piano key dip, This third lever totally eliminating the traditional friction. A simple, easy retrofit.

Patents relating to the problem of excessive friction
Finholm #4,774,868
Steinway #5,511,454
Steinway #5,911,167
Baldwin #6,232,537

### DESCRIPTION

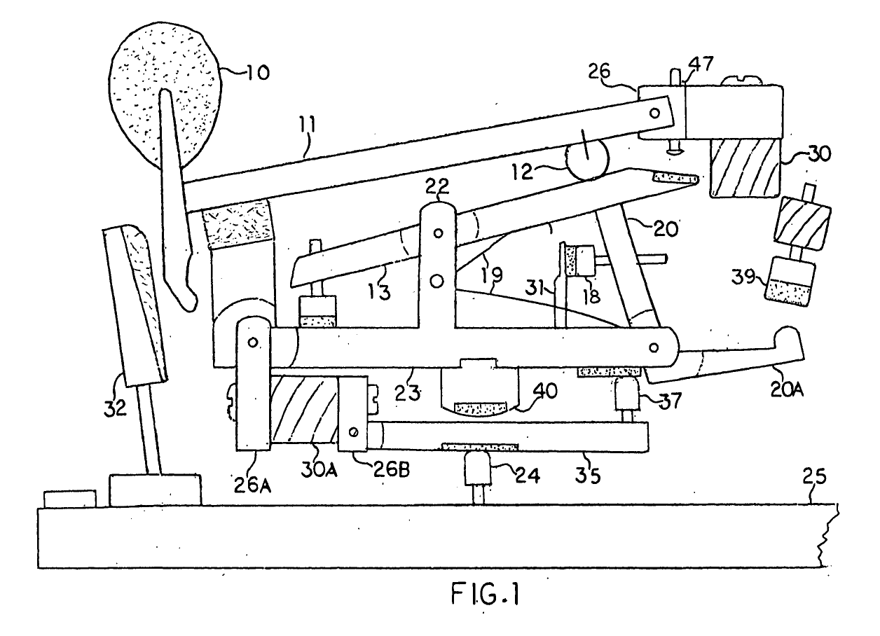

FIG. 1 Shows a flange 26 pivoting a hammer shank 11 carrying a piano hammer 10 and a knuckle 12, a second flange 26A pivoting a wippen lever 23 a jack 20 being pivoted from the wippen lever, an upstanding portion 22 of the wippen lever pivoting a repetition lever 13, the upstanding portion carrying a double ended spring 19 an upper end supporting the repetition lever, the lower end supporting the jack, a regulating button 18 carried by the jack acting against a spoon 31 effected by the lower end of the spring 19 supporting the jack, a third lever 35 being pivoted from a flange 26B attached to a rail 30A carrying flange 26A pivoting the wippen lever 23, the end of the third lever 35 lifting the end of the wippen lever 23 totally eliminating the traditional friction between the knuckle and the jack. The third lever being supported by a capstan screw 24 and being detached from the appendage 40 of the wippen lever 23.

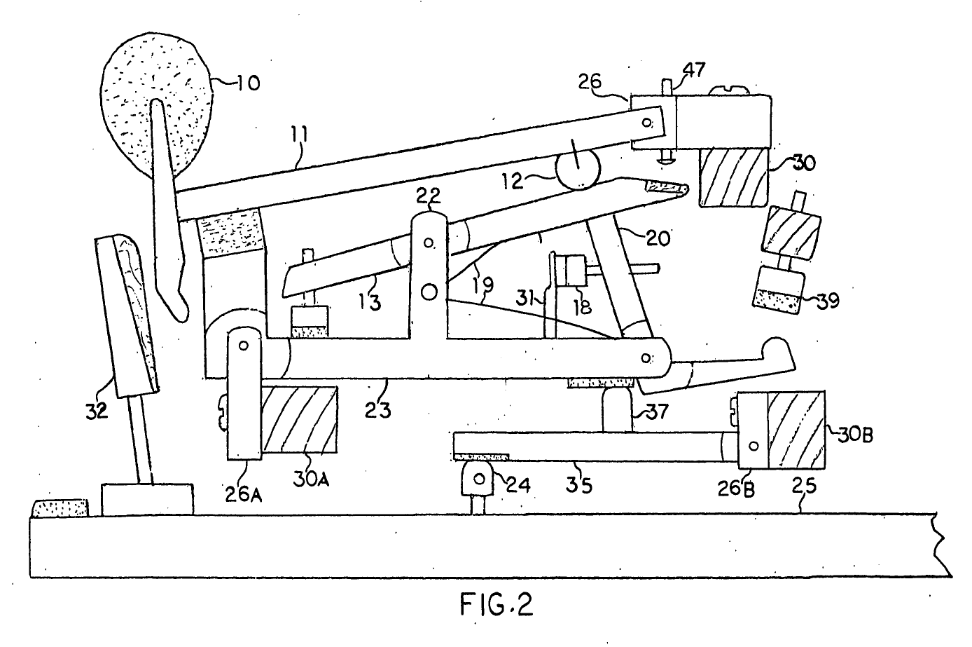

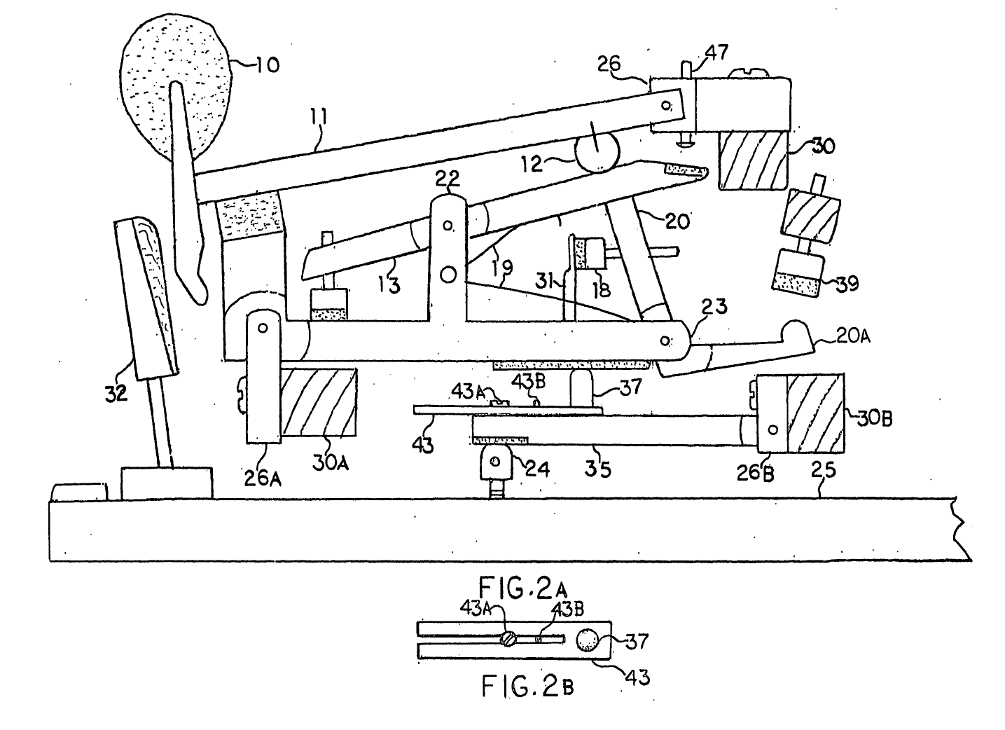

FIG. 2 Shows the third lever 35 pivoted from a flange 26B on a rail 30B the distal end of the third lever 35 resting on a capstan screw 24 on the piano key 25, A knob 37 between the ends of the third lever lifting the end of wippen lever 23.

FIG. 2A Shows the knob 37 on a friction regulating strip 43 having a longitudinal opening held down by a screw 43A, a pin 43B stabilizing the strip 43, the strip 43 regulating the knob 37 to a selected point under the wippen lever for a selected amount of friction

FIG. 2B Shows a top view of the friction regulating strip 43

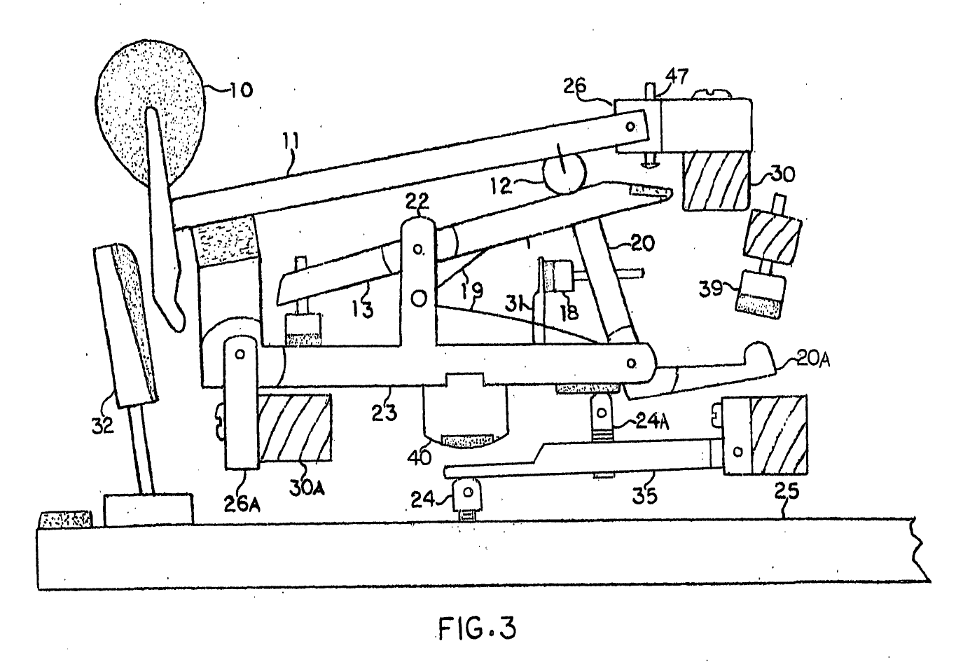

FIG. 3 Shows the wippen lever 23 with the traditional appendage 40 a capstan screw 24 between ends of the third lever 35 supporting the end of the wippen lever 23.

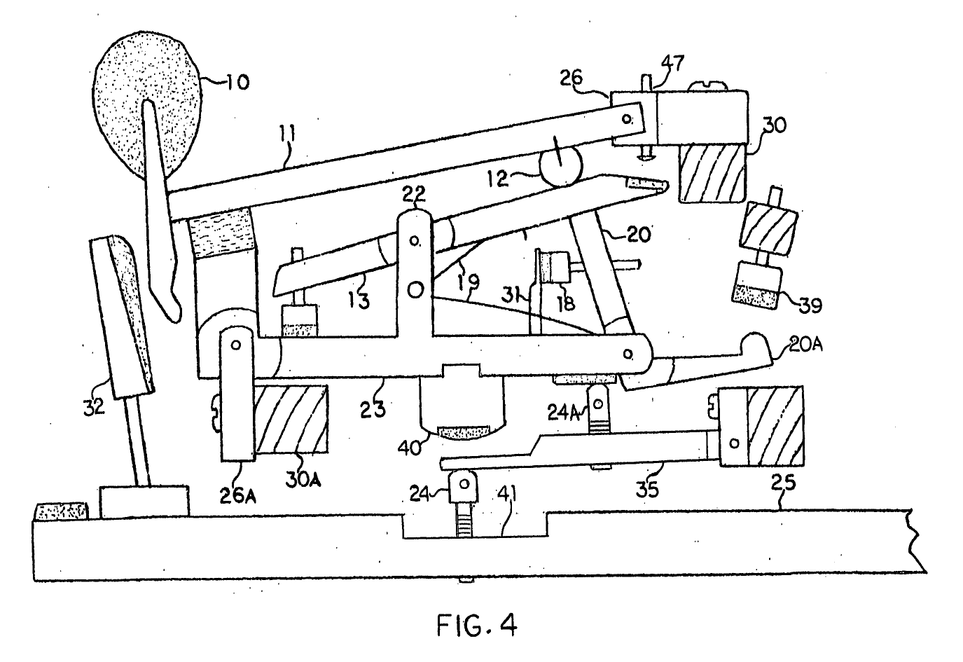

FIG. 4 is similar to FIG. 3 with a depression 41 in the piano key 25.

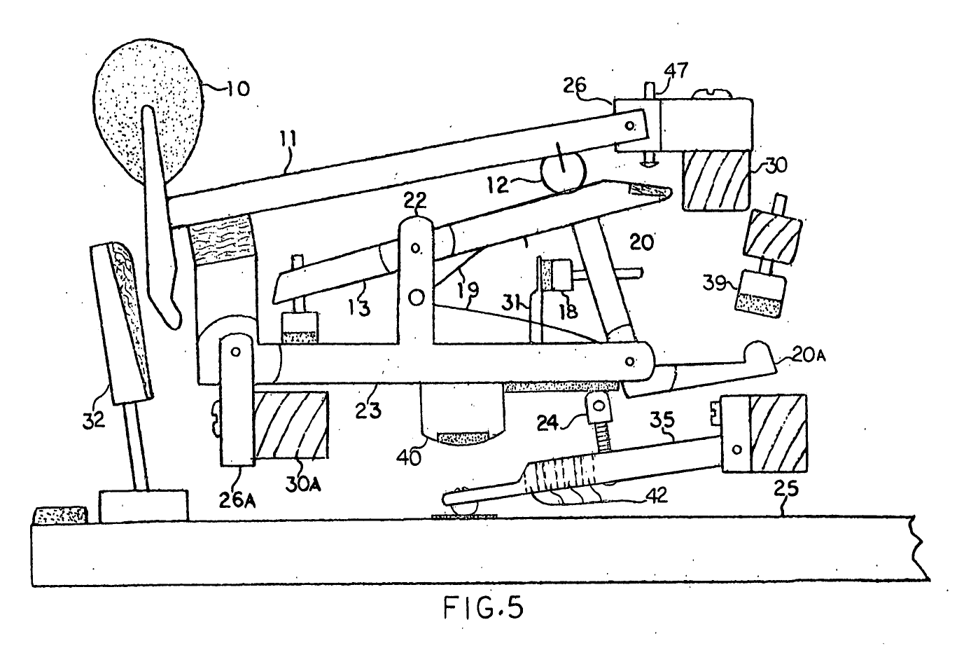

FIG. 5 Shows the capstan screw 24 removed from the piano key 25 and positioned on the third lever 35 supporting the end of the wippen lever 23, the third lever 35 having threaded holes 42 for the capstan screw 24 to enter for a selected amount of friction.

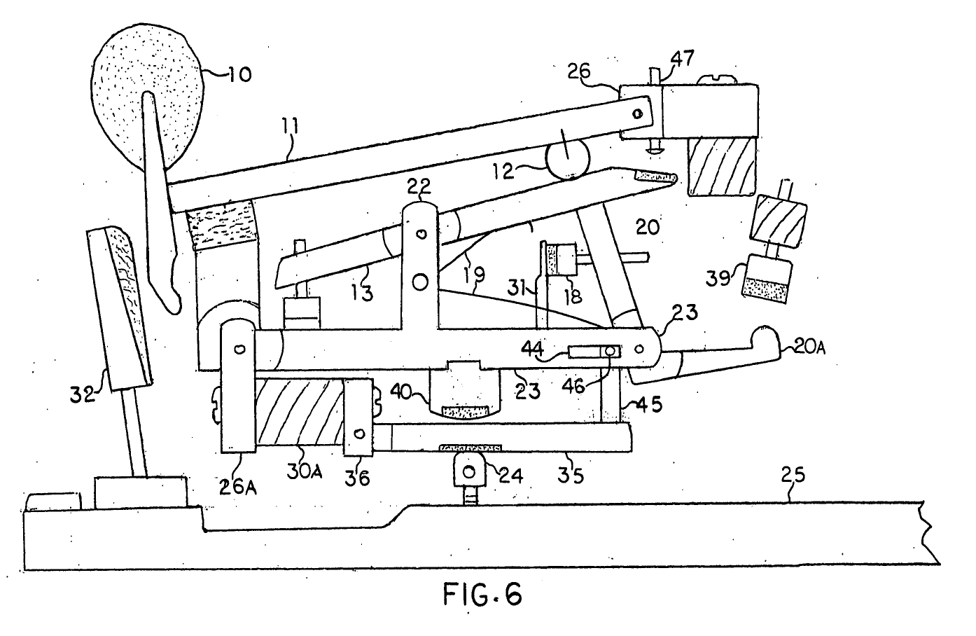

FIG. 6 Shows a lifting post 45 on third lever 35 having a pin 46 residing in slots 44 in sides of the wippen lever 23, lifting the end of the wippen lever 23.

### OBJECTS OF THE INVENTION

The primary object is to provide a grand piano action totally devoid of the traditional friction between the jack and the knuckle causing noise wear and tear on the knuckles to a greater extent in the bass section.

Another object is to provide a grand piano permitting the pianist to play comfortably without fatigue evoking unheard of nuances of tone and permitting a rapid pianissimo.

Another object is to regulate the traditional friction in degrees from zero friction.

### REFERENCE NUMERALS

10 piano hammer
11 hammer shank
12 knuckle
13 repetition lever
18 regulating button
19 spring
20 jack
20A arm
22 upstanding portion
23 wippen lever
24 capstan screw
24A capstan screw
25 piano key
26 flange
26A flange
26B flange
30 rail
30A rail
30B rail
31 spoon
32 back check
35 third lever
37 knob
39 escapement letoff button
40 appendage
41 depression
42 hole plurality
43 friction regulating strip
44 slots
45 post
46 pin
47 regulating drop screw

### CLAIMS RELATING TO FIGURES

claim 1 FIG. 1,6,
claim 2 FIG. 2,
claim 3 FIG. 1,
claim 4 FIG. 2,
claim 5 FIG. 1,
claim 6 FIG. 2,
claim 7 FIG. 2A,
claim 8 FIG. 2A,
claim 9 FIG. 5,
claim 10 FIG. 5,
claim 11 FIG. 5,
claim 12 FIG. 5,
claim 13 FIG. 4,
claim 14 FIG. 2A,
claim 15 FIG. 2A,
claim 16 FIG. 6,
claim 18 FIG. 1,
claim 19 FIG. 2,

I claim:

1. A revolutionized grand piano action including a third lever under a first lever a wippen lever pivoting a jack being under a second lever a repetition lever, said wippen lever pivoting said repetition lever by an upstanding portion of said wippen lever; said action comprising a flange pivoting a hammer sank carrying a piano hammer and a knuckle dependent from said hammer shank, a second flange pivoting said wippen lever pivoting said jack, said jack adjoining said knuckle, an arm of said jack opposing an escapement letoff button, said upstanding portion of said wippen lever pivoting said repetition lever, said upstanding portion carrying a double ended spring, the upper end supporting said repetition lever, the lower end supporting said jack, a regulating button carried by said jack acting against a spoon carried by said wippen lever, said third lever being supported by a capstan screw on the piano key, said third lever being pivoted from a third flange attached to the rail carrying said second flange pivoting said wippen lever, said third lever lifting said wippen lever.

2. A grand piano action comprising a hammer carrying a piano hammer and a knuckle dependent from said hammer shank, said knuckle resting on a repetition lever pivoted from an upstanding portion of a wippen lever, said wippen lever carrying a jack with arm, said upstanding portion carrying a spring the first end supporting said repetition lever, the second end supporting said jack, said arm of said jack opposing an escapement letoff button, said grand piano action including a third lever completely eliminating friction between said jack and said knuckle, the distal end of said third lever resting on a capstan screw on the piano key, a means between the ends of said third lever lifting said wippen lever.

3. The grand piano action according to claim 1 wherein said third level including a knob lifting said wippen lever.

4. The grand piano action according to claim 2 wherein said third lever between said ends of said third lever including a knob lifting said wippen lever.

5. The grand piano action according to claim 1 wherein said third lever including a capstan screw lifting said wippen lever.

6. The grand piano action according to claim 2 wherein said third lever between said ends of said third lever including a capstan screw lifting said wippen lever.

7. The grand piano action according to claim 3 wherein said knob on said third lever being on a strip having a longitudinal opening to be adjustable along said third lever to lift a selected point under the wippen lever for a selected amount of friction, a screw in said opening in said third lever holding said strip.

8. The grand piano action according to claim 4 wherein said knob between said ends of said third lever being on a strip having a longitudinal opening to be adjustable along said third lever to lift a selected point under said wippen lever for a selected amount of friction, a screw in said opening in said third lever holding said strip.

9. The grand piano action according to claim 2 wherein said capstan screw on said piano key being removed from said piano key and positioned on said third lever under said wippen lever.

10. The grand piano action according to claim 9 wherein the end of said third lever resting on a spot on said piano key once occupied by said capstan screw.

11. The grand piano action according to claim 10 wherein said spot on said piano key being covered with felt.

12. The grand piano action according to claim 9 wherein said lever including a plurality of threaded holes for said capstan screw to enter for a selected amount of friction between the jack and the knuckle.

13. The grand piano action according to claim 9 wherein said capstan screw on said piano key being in a depression in said piano key.

14. The grand piano action according to claim 4 wherein said knob lifting said end of said wippen lever being carried by a friction regulating strip having a longitudinal opening, a screw in said opening in said third lever holding said strip.

15. The grand piano action according to claim 14 wherein said friction regulating strip including a stabilising pin in said opening in said third lever.

16. The grand piano action according to claim 1 wherein said end of said third lever including a post having a hold disposed transversely with respect to said end of said wippen lever, said end of said wippen lever including a slot in both sides of said end of said wippen lever, a pin residing in said hole in said post and residing in said slots in said wippen lever, said pin lifting said slots by said capstan screw on said piano key lifting said third lever.

17. A conventional grand piano action including a third lever lifting the distal end of the wippen lever carrying the jack completely eliminating the traditional friction between said jack and the knuckle dependent from the hammer shank carrying the piano hammer.

18. The conventional grand piano action according to claim 17 wherein said third lever being pivoted from a flange fixed to the rail carrying the flange pivoting said wippen lever.

19. The conventional grand piano action according to claim 18 wherein said third lever being pivoted from a flange carried by a rail remote of said rail carrying said flange pivoting said wippen lever.

20. The grand piano action according to claim 9 wherein said capstan screw on said piano key being said removed from said piano key and repositioned on said piano key closer to said end of said wippen lever supporting said wippen lever.
